(19) United States
(12) Patent Application Publication
(10) Pub. No.: US 2018/0016088 A1
(43) Pub. Date: Jan. 18, 2018

(54) COMPOSITION CONTAINER WITH A LIGHTING DEVICE TO ILLUMINATE A TARGET AREA

(71) Applicant: The Dial Corporation, Scottsdale, AZ (US)

(72) Inventors: Mary J Conway, Phoenix, AZ (US); Joel Faaborg, Phoenix, AZ (US); Aleidatje M Lester, Phoenix, AZ (US); Nancy D Rogers, Chandler, AZ (US)

(73) Assignee: The Dial Corporation, Scottsdale, AZ (US)

(21) Appl. No.: 15/211,025

(22) Filed: Jul. 15, 2016

(51) Int. Cl. B65D 83/14; B65D 83/32; F21V 33/00; B65D 83/16; F21V 23/04

(52) U.S. Cl. CPC B65D 83/753; B65D 83/16; F21V 23/04; F21V 33/0004; B65D 83/32; F21Y 2115/10; B65D 83/752

(57) ABSTRACT

A composition container is described. The composition container includes a reservoir to hold a volume of the composition. The container also includes a dispensing device to dispense the composition from the reservoir onto an application surface. A lighting device of the composition container illuminates a target area of the application surface during the dispensing of the composition from the reservoir onto the application surface. An actuating device of the composition container selectively activates the dispensing device and the lighting device.

### FIELD OF THE INVENTION

The present invention generally relates to a composition container, and more particularly relates to a composition container that includes a lighting device to illuminate a target area of an application surface during application of the composition to the application surface.

### BACKGROUND OF THE INVENTION

A composition container is used to hold a composition for use by a user. Various types of compositions can be disposed within a container. For example, personal care compositions are retained in containers that may be held by a user, and used in application of the composition to the user's hair and/or skin. Examples of such personal care compositions include hair spray, deodorant and/or antiperspirant spray, perfume, cologne, and bug spray among other hair care products, skin care products or personal care products. Compositions other than personal care compositions are also housed within containers. Examples of non-personal care compositions include lubricating spray, compressed air, a surface cleaner, a fabric cleaner, an adhesive, and a spray paint among other compositions. These are just a few examples, and any number of compositions can be disposed within a composition container. The breadth of examples, indicates the wide use of compositions, and containers for those compositions in modern society. Accordingly, a composition container that provides additional and unique benefit may be desirable for the additional consumer advantages it provides.

Accordingly, it is desirable to have a composition container that accommodates different compositions disposed therein as well as providing additional consumer advantages. It is further desirable to provide a composition container that enhances and increases the effective distribution of the composition disposed therein on the target surface. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A composition container is described. The container includes a reservoir to hold a volume of a composition. The container also includes a dispensing device to dispense the composition from the reservoir onto an application surface. The container further includes a lighting device to illuminate a target area of the application surface during the dispensing of the composition from the reservoir onto the application surface. An actuating device of the container selectively activates the dispensing device and the lighting device.

The present application also describes a consumer product. The consumer product includes a reservoir to hold a volume of a consumer composition and the consumer composition disposed within the reservoir. A dispensing device of the consumer product is coupled to the reservoir and ejects a portion of the consumer composition onto an application surface. A lighting device of the consumer product illuminates a target area of the application surface during ejection of the portion of the composition onto the application surface. The consumer product further includes an actuator to activate both the lighting device and the dispensing device.

The present application also describes a composition container. The composition container includes a reservoir to hold a volume of a personal care composition. A dispensing device of the composition container dispenses a portion of the personal care composition from the reservoir onto an application surface and a lighting device illuminates a target area of the application surface during ejection of the portion of the personal care composition onto the application surface. The lighting device includes a lighting element to illuminate the target area and a power source to provide electrical power to activate the lighting element. An actuating device of the composition container activates the dispensing device and the lighting device. When in a first activated position, the actuating device activates the lighting device and when in a second activated position, the actuating device activates the lighting device and the dispensing device.

### BRIEF DESCRIPTION OF THE DRAWINGS

The present invention will hereinafter be described in conjunction with the following drawing figures, wherein like numerals denote like elements, and

FIG. 1 is a block diagram of a composition container having a lighting device, according to an example of the principles described herein.

FIG. 2 is a diagram of a composition container having a lighting device, according to an example of the principles described herein.

FIG. 3 is a cross-sectional diagram of a composition container having a lighting device, according to an example of the principles described herein.

FIGS. 4A and 4B are diagrams of an actuating device in different positions, according to an example of the principles described herein.

FIGS. 5A-5C are diagrams of an actuating device in different positions, according to an example of the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As described above, a wide variety of compositions, such as personal care compositions and others compositions are used in society. In some cases, the compositions are used daily, and can even be used multiple times a day. The compositions are housed in containers that 1) retain the composition and 2) allow for the ejection of the composition disposed therein onto a target surface. However, in some cases, the containers, and the ejection of the composition, are ineffective or inefficient. For example, in low light conditions, or in environments where light is not readily available, a consumer may be unsure as to the dispersal pattern of the composition. For example, a user may be applying a bug spray to a skin surface during the night, and while outdoors. The absence of light increases the difficulty of effectively directing the bug spray to the target area, and a user may waste product in trying to ascertain where the bug spray nozzle is pointed, and in determining a dispersal pattern of the bug spray. In another example, a consumer may be working on an automobile engine, Due to the complex and tight layout of the engine components, there may be inadequate lighting to those internal components. Applying a composition, such as lubricant to these internal components is therefore made more difficult as a user may be unsure as to where the lubricant will be dispersed and a dispersal pattern of the lubricant.

To alleviate these and other concerns, a composition container of the present application includes a lighting device. The lighting device illuminates a target area of the application surface. The illumination from the target area provides greater lighting such that a user can more easily see to apply the composition. The lighting device also identifies a target area. Thus, not only can a user see the application surface better, but can see generally on what region of the application surface the composition will be deposited. That is, the light pattern emitted by the lighting device may correspond to, and be larger than, the dispersal pattern of the composition on the surface. So doing allows a user to see the surface where the composition is to be deposited as well as see a coverage area of the composition.

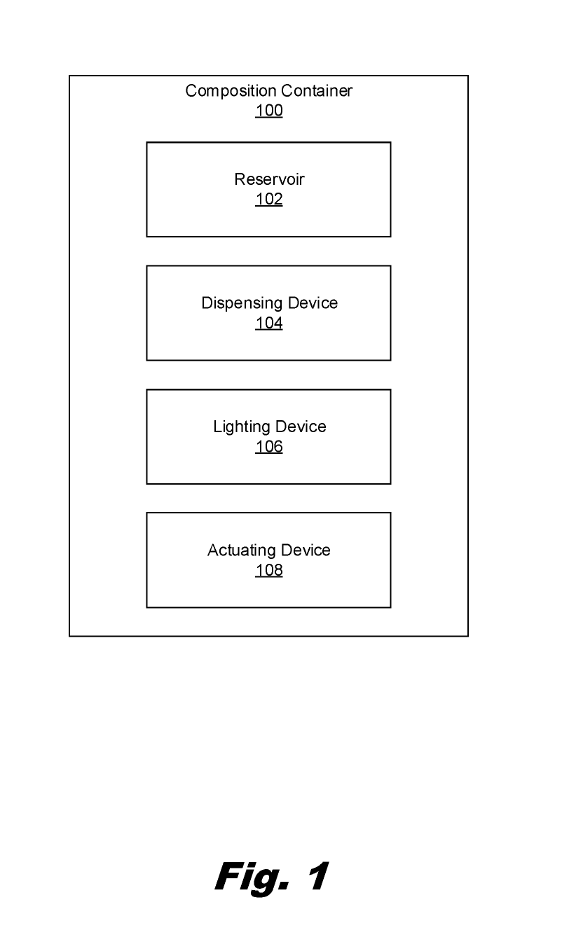

Turning now to the figures, FIG. 1 is a block diagram of a composition container (100) having a lighting device (106), according to an example of the principles described herein. The composition container (100) includes a reservoir (102) to hold a volume of composition. The reservoir (102) may be made of any material including plastic, aluminum, or a composite among other types of reservoir (102) material. In other words, the reservoir (102) is made of any material that can retain a volume of the composition disposed therein. Examples of compositions that may be disposed within the reservoir (102) include hairspray, an antiperspirant spray, an antiperspirant/deodorant spray, a surface cleaner, a fabric cleaner, a bug spray, an adhesive, or a spray paint. While specific examples are provided of specific compositions disposed within the reservoir (102), any number of compositions that are to be applied to a surface may be disposed therein.

Returning to the reservoir (102). In some examples, the reservoir (102) is an aerosol reservoir (102). That is, the reservoir (102) can contain the composition and a propellant, wherein the propellant is pressurized. In this example, the reservoir (102) is sufficiently rigid to contain the pressurized components. In one specific example, the aerosol reservoir (1020 is formed of a metallic material or a rigid plastic. In other examples, the reservoir (102) is a non-aerosol reservoir (102) meaning that the composition disposed therein is not under pressure and the composition is ejected via pressure changes, which pressure changes can be effectuated by a trigger for example.

The container (100) also includes a dispensing device (104) to facilitate the ejection of the composition from the reservoir (102). In an aerosol reservoir (102), the dispensing device (106) includes at least a valve within the reservoir (102) and an opening through which the composition is ejected. As the valve is opened, the pressurized propellant forces the composition to flow out the opening of the dispensing device (104). In this example, the composition disposed therein is forced out of a small opening as an aerosol or a mist. In another example, the reservoir (102) is a non-aerosol reservoir meaning that the composition is disposed within the reservoir (102 at atmospheric pressure. In this example, other forces, such as gravity, or physical manipulation of the container, i.e., squeezing, expels the composition from the reservoir (102). In an example of a non-aerosol reservoir (102), the dispensing device (104) includes a pump, in which a first cycle of the pump expels the composition from a holding chamber through an opening of the dispensing device (104), as a spray for example. A second cycle of the pump draws the composition from the reservoir (102) into the holding chamber to be expelled via a subsequent first cycle of the pump. The dispensing device (104) of a non-aerosol reservoir (102) also includes an opening and other components used in ejecting the composition from the reservoir (102).

To activate the dispensing device (104), the container (100) may include an actuating device (108). For example, in an aerosolized container (100), i.e., the contents of the container (100) are pressurized and a trigger, or button, on the container (100) opens a valve that facilitates movement of the composition through the dispensing device (104). The composition is then forced out an opening of the dispensing device (104). The opening may be small such that the composition is ejected as a spray. In another example, the actuating device (108) is a trigger that initiates the first cycle of the pump of a non-aerosol reservoir (102). For example, a squeeze of the trigger initiates a first cycle of the pump which pushes a piston into a holding chamber to expel the composition from the holding chamber. As the trigger is released, a second cycle of the pump is initiated as the piston is retracted from the holding chamber which draws the composition into the holding chamber from the reservoir (102). In yet another example, the actuating device (108) activates the dispensing device (104) to draw the composition to the dispensing device (104), wherein the composition mixes with oxygen to form a foam upon ejection of the composition from the container (100).

While specific reference is made to specific dispensing devices (104) and actuating devices (108), any type of dispensing device (104) and actuating device (108) may be used. For example, a dispensing device (104) may include any opening and dispensing mechanism, and the actuating device (108) may be any device that draws the composition through the dispensing device (104).

The container (100) also includes a lighting device (106) to illuminate a target area of the application surface during the dispensing of the composition from the reservoir (102) onto the application surface. The lighting device (106) includes a number of components to provide such illumination. For example, the lighting device (106) may include lighting elements that illuminate the target area, a power source such as a battery that provides electrical power to the lighting elements, and circuitry to deliver electrical power to the lighting elements. The lighting element of the lighting device (106) may be any type of lighting element. For example, the lighting element may be a light emitting diode (LED) lighting element. Such an LED lighting element provides illumination to the target area as well as to illuminate the environment around the target area. In another example, the lighting element is a ultra-violet (UV) lighting element. A UV lighting element can be used to identify stains that are otherwise invisible to the naked eye. For example, some stains, such as pet urine, become visible when exposed to UV light. In this example, the lighting device (106) not only illuminates a target area of the application surface, but also identifies a stain that could require treatment by the composition in the reservoir (102). The lighting device (106) may include other components. For example, the lighting device may include a number of electrical circuit components such as resistors, diodes, and capacitors to allow the lighting element to remain powered for a period of time after being disconnected from the power source of the lighting device (106).

Like the dispensing device (104), the lighting device (106) is activated by the actuating device (108). For example, during use, a user depresses the actuating device (108), which depression completes an electrical circuit between the power source and the lighting element of the lighting device (106) to as to activate the lighting element. The lighting element is disposed on the reservoir (102) so as to illuminate an area of the application surface where the composition is to be deposited. In some examples as will be described below, the actuating device (108) actuates the dispensing device (104) and the lighting device (106) independently, or simultaneously.

The container (100) as described herein, therefore allows for illumination of a target area of an application surface as a composition is applied to the target area. That is, the light pattern emitted by the lighting element of the lighting device (106) corresponds to a dispersal pattern of the composition, such that a user can precisely direct the composition onto a desired surface. Doing so allows for more effective placement of the composition on the surface and thus leads to customer satisfaction. Still further, the lighting device (106) provides greater illumination in general to the surrounding area, thus providing greater visibility during the application of the composition to the target area.

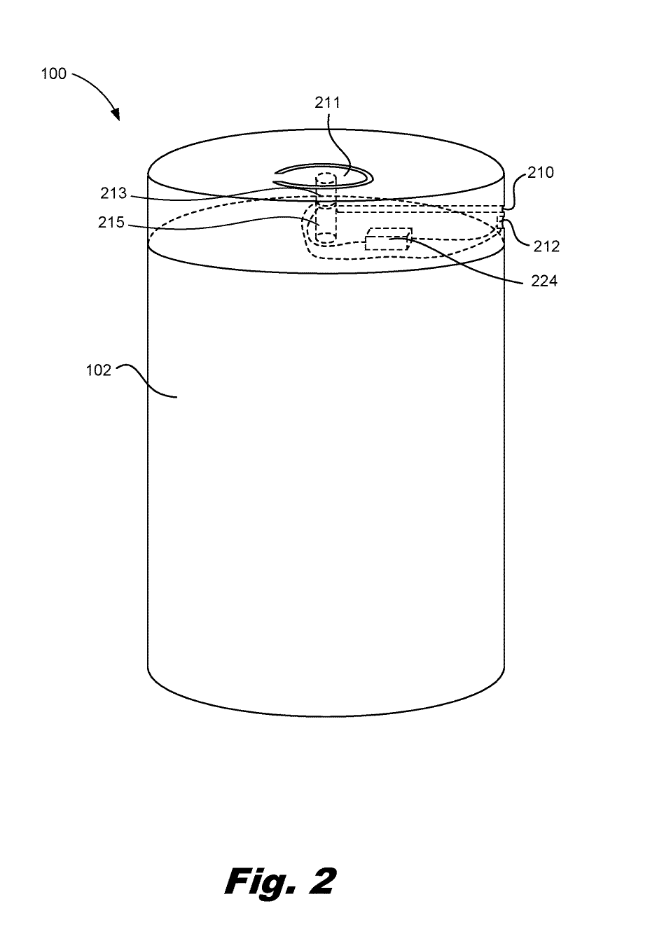

FIG. 2 is a diagram of a composition container (100) having a lighting device (106), according to an example of the principles described herein. While FIG. 2 depicts a particular shape of the container (100), any shape could be used. In FIG. 2, components with dashed lines indicate that the component is internal to the lid component of the container (100). FIG. 2 depicts the reservoir (102) as well as the actuating device (FIG. 1, 108) that selectively activates both the dispensing device (FIG. 1, 106), which dispensing device (FIG. 1, 106) includes an opening (210) through which the composition passes. In the example depicted in FIG. 2, the actuating device (FIG. 1, 108) includes a button (211) or other surface which is depressed by a user. As the composition container (100) may be plastic, the button (211) may include a living hinge, meaning its motion is enabled by the deformation of a piece of plastic with a small cross-sectional area. As the button (211) is depressed, a first rod (213) of the actuating device (FIG. 1, 108) pushes against a second rod (215) of the actuating device (FIG. 1, 108). The depression of the second rod (215) activates the dispensing device (FIG. 1, 106) such that the composition disposed within the reservoir (102) is ejected out the opening (210).

In other words, the dispensing device (FIG. 1, 106) includes an opening (210) and in some examples other components such as a valve, a drip tube, and a piston and holding chamber, among other components to aid in the ejection of the composition from the reservoir (102). The actuating device (FIG. 1, 108) also activates the lighting device (FIG. 1, 106), which lighting device (FIG. 1, 106) includes a lighting element (212) that illuminates a target area. For example, the lighting device may include a power source (224) and electrical circuitry to create a closed circuit between the power source (224) and the lighting element (212). Each of the first rod (213) and the second rod (215) may include electrical contact pads that when in contact, close the circuit between the power source (224) and the lighting element (212) such that the power source (224) provides electrical power to, and activates the lighting element (212).

During use, activation of the actuating device (FIG. 1, 108), can simultaneously or independently, activate the dispensing device (FIG. 1, 104) and the lighting device (FIG. 1, 106). Put another way, activation of the actuating device (FIG. 1, 108) can either simultaneously or independently, turn on the lighting element (212), and eject the composition through the opening (210).

As depicted in FIG. 2, the lighting element (212) of the lighting device (FIG. 1, 106) may be disposed near the opening (210) of the dispensing device (FIG. 1, 104) so as to more accurately illuminate the target area where the composition will be deposited. However, while FIG. 2 depicts the lighting element (212) in a particular location on the container (100), the lighting element (210) may be positioned at any location, so long as the light beams emitted from the lighting element (212) emit a lighting pattern that corresponds to an area of ejection of the composition through the opening (210). As described above, the lighting element (212) may be an LED lighting element, a UV lighting element, or any other lighting element that illuminates a target surface.

As described above, the use of the lighting device (FIG. 1, 106) allows for use of the container (100) and application of the composition in low light conditions, or in environments where lighting is reduced. Still further, the lighting device (FIG. 1, 106) may prevent overspray. That is, during use, a distance between the opening (210) and the target surface affects the dispersal pattern of the composition through the opening (210). A user may not be cognizant of this effect of distance on dispersal pattern, which could result in 1) over-application of the composition if the container (100) is too close to the application surface or 2) under-application of the composition if the container (100) is too far away from the application surface, or 3) application of the composition to other than the target area. Such over or under application can lead to a dissatisfactory user experience and/or wasted product. However, by illuminating a target area of the application surface, in some cases prior to ejection of the composition, the lighting device (FIG. 1, 106) indicates the dispersal pattern of the composition through the opening (210) thus reducing the likelihood of over-application or under-application.

While FIG. 2 depicts a specific configuration of the dispensing device (FIG. 1, 104), the lighting element (FIG. 1, 106) and the actuating device (108), various configurations may be implemented, and the depicted configuration is an example. In other words, the actuating device (108) may be otherwise configured so as to allow dispersal of composition through the opening (212).

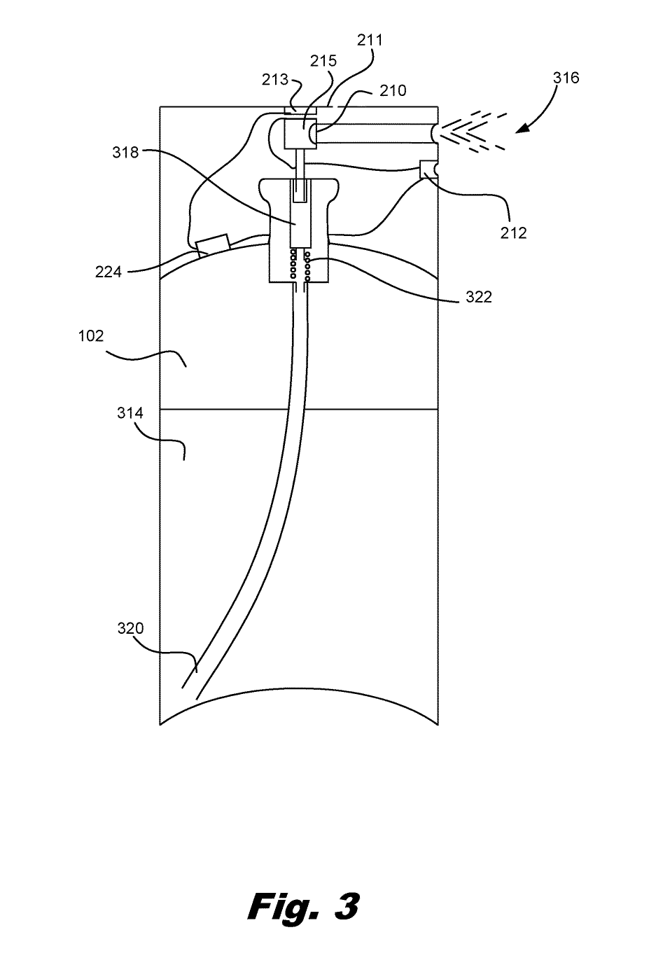

FIG. 3 is a cross-sectional diagram of a consumer product having a lighting device (FIG. 1, 106), according to an example of the principles described herein. The consumer product includes the container (FIG. 1, 100) and the composition (314) disposed therein. FIG. 3 depicts the reservoir (102) which holds a volume of the composition (314). The composition (314) may take many forms. For example, the composition (314) may be a fluid, a gel, an emulsion, a foam, or a foaming gel. In this example the dispensing device (FIG. 1, 104), of which the opening (210) is a component, may take any form to suitably discharge the composition (314) based on its form. The composition (314) may serve any number of functions. For example, the composition (314) may in some cases be a personal care composition such as a hair spray, an antiperspirant spray, an antiperspirant/deodorant spray, and a bug spray. The composition (314) may be a non-personal care composition such as a surface cleaner, a fabric cleaner, an adhesive, or a spray paint. While specific mention is made of particular compositions (314), the composition (314) may be any that to be retained in a reservoir (102) and dispensed.

FIG. 3 also provides additional detail on an aerosol-type reservoir (102). In this example, the dispensing device (FIG. 1, 104) further includes a piston (318) that when moved down by the actuating device (FIG. 1, 108), which actuating device (FIG. 1, 108) in this example includes the first rod (213), the second rod (215), and the button (211) opens to allow composition to flow up the drip tube (320) and out the opening (210). The piston (318) is maintained in a closed position via a spring (322) of the dispensing device (FIG. 1, 104).

As described above, the container of the consumer product may dispense the composition (314) as a spray (316). This may be carried out as the composition (314) passes through a small opening (210). Accordingly, the container (FIG. 1, 100) may include components to facilitate the ejection of the composition (314) as an aerosol or a mist. While FIG. 3 specifically depicts an aerosolized container (FIG. 1, 100), the present container may be a non-aerosolized container as well.

Still further, as described above, the consumer product includes a lighting device (FIG. 1, 106) which includes a lighting element (212) such that the target area is illuminated and identified. The lighting element (212) is activated by the actuating device (FIG. 1, 108). For example, upon depression of the button (211), electrical contact pads on the first pad (213) and the second pad (215) may come into contact forming a closed circuit between a power source (224) of the lighting device (FIG. 1, 106), and the lighting element (212) of the lighting device (FIG. 1, 106), thus allowing the lighting element (212) to illuminate the target surface.

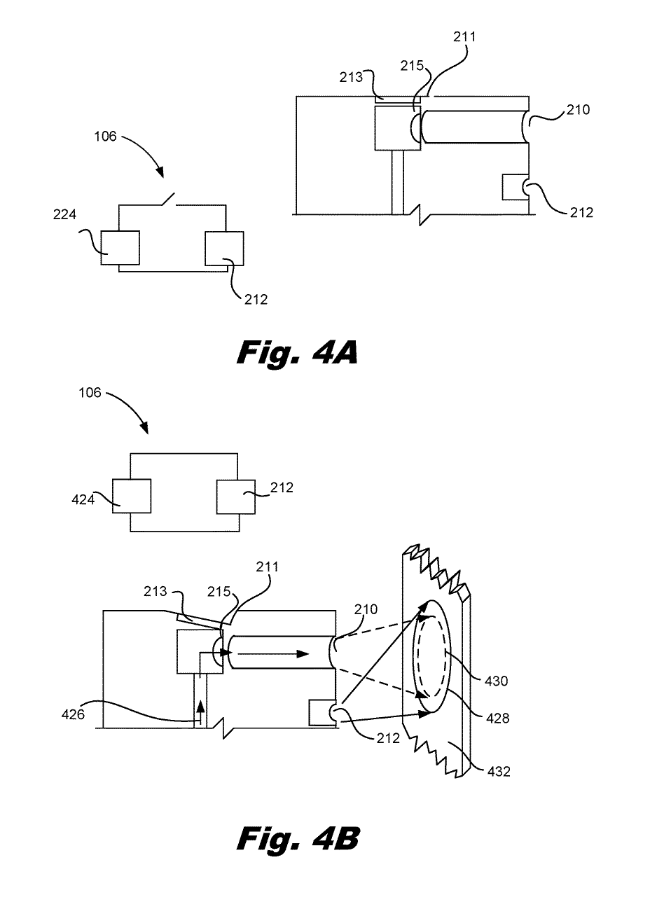

FIGS. 4A and 4B are diagrams of an actuating device (FIG. 1, 108) in different positions, according to an example of the principles described herein. As described above, the actuating device (FIG. 1, 108) selectively activates both the dispensing device (FIG. 1, 104) and the lighting device (106), which lighting device (106) is depicted in FIG. 4A as a basic circuit diagram. While FIG. 4A depicts a particular circuit diagram for the lighting device (106), any number of different or additional circuitry components could be used to provide a lighting device (106) that illuminates a target area. In an unselected position, as depicted in FIG. 4A, neither the dispensing device (FIG. 1, 104), nor the lighting device (106) is activated. In other words, the composition (FIG. 3, 314) is not passing through the opening (210). In this unselected position, the lighting device (106) is an open circuit, meaning that the power source (224) such as a battery does not form a closed circuit with the lighting element (212). With such an open circuit, the lighting element (212) cannot emit light. By comparison, in an activated position, as indicated in FIG. 4B, both the dispensing device (FIG. 1, 104) and the lighting device (106) are active. The actuating device (FIG. 1, 108) moves from an inactive to an active position via user interaction. For example, a user depresses the button (211) to move the first rod (213) to contact the second rod (215). Doing so moves the second rod (215) down such that the composition flows out the container, and out the opening (210) as depicted by the arrows (426).

Still further, in this example, the depression of the first rod (213) forms an electrical contact between the power source (224) and the lighting element (212) so as to close an electrical circuit between a battery of the lighting device (106) and a lighting element (212) of the lighting device (106).

In this example, the light emanating from the lighting element (212) may form a light pattern (428) on an application surface (432) that is larger than the dispersal pattern (430) of the composition on the target surface (432). In other words, the lighting device (106) illuminates a target area that is larger than an area covered during the dispensing of the composition (FIG. 3, 314) from the reservoir (FIG. 1, 102) onto the application surface (432). Using a lighting pattern that is larger than a dispersal pattern not only illuminates the target area, but also reduces the amount of overspray as a user knows precisely where a composition is to be deposited.

While FIGS. 4A and 4B depict a specific operation of an actuating device (FIG. 1, 108) in a specific type of container (FIG. 1, 100), the principles described herein may apply equally to various types of containers including aerosol and non-aerosol type containers (FIG. 1, 100). For example, squeezing of a trigger to a first level may complete an electrical circuit such that a lighting element (212) emits light, and squeezing the trigger to a second level may move a piston into a holding chamber to expel composition from the opening (212). Release of the trigger may move the piston from the holding chamber to draw composition into the holding chamber from the reservoir (FIG. 1, 102). Moreover, While FIGS. 4A and 4B depict a specific circuit configuration for the lighting device (106), different circuit configurations could be implemented in accordance with the principles described herein.

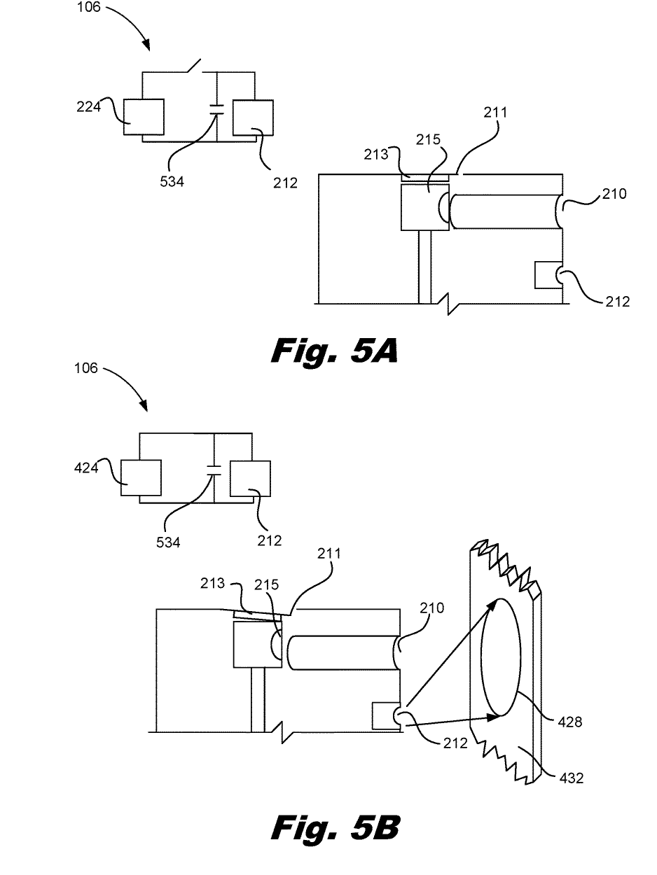

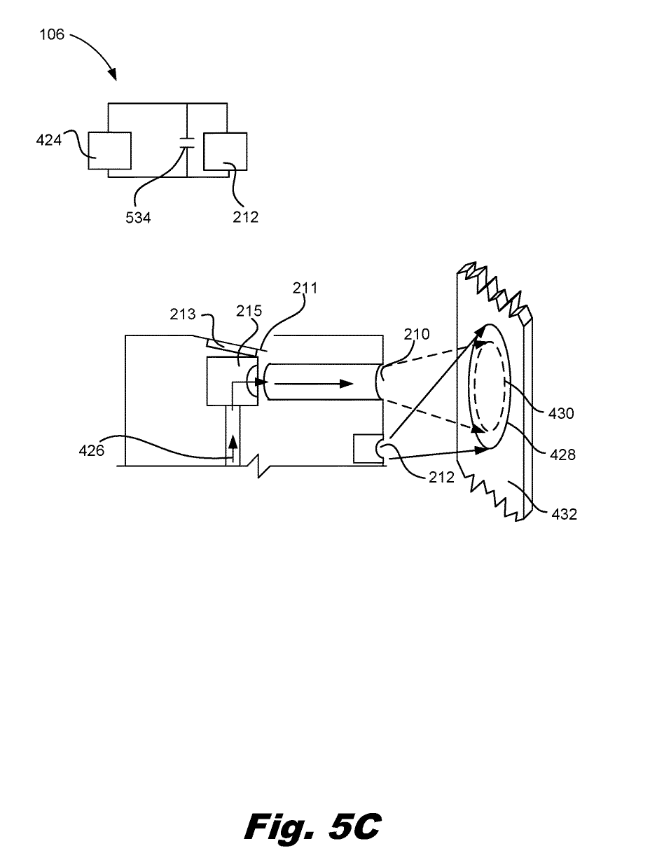

FIGS. 5A-5C are diagrams of an actuating device (FIG. 1, 108) in different positions, according to an example of the principles described herein. Specifically, FIGS. 5A-5C depict a single actuating device (FIG. 1, 108) that independently activates the lighting device (106) from the dispensing device (FIG. 1, 104). While FIG. 5A depicts a particular circuit diagram for the lighting device (106), any number of different or additional circuitry components could be used to provide a lighting device (106) that illuminates a target area. In FIG. 5A, the actuating device (108) is in an inactivated position, meaning that neither the dispensing device (FIG. 1, 104), nor the lighting device (106) are activated. In other words, the composition (FIG. 3, 314) is not passing through the opening (210). As described above, in some examples, the lighting device (106) includes additional components. For example, as depicted in FIG. 5A, the lighting device (106) includes at least a capacitor (534) coupled in parallel with the lighting element (212). In this example, when the closed loop is formed, for example by depressing the first rod (213) to contact the second rod (215), the power source (224) 1) gives power to the lighting element (212) and charges the capacitor (534) up. As the first rod (213) is raised, thus creating an open circuit, the power source (224) is disconnected from the lighting element (212), but the capacitor (534), which is still coupled to the lighting element (212), acts as a power source, albeit temporary, for the lighting element (212). In this fashion, the lighting element (212) remains on for a period of time after the actuating device (FIG. 1, 108) has gone through an activation cycle and returned to an inactivated position. While FIGS. 5A-5C depict a specific circuit diagram, different, or additional circuit components such as resistors, transistors, and diodes could be used in the lighting device (106).

As depicted in FIG. 5B, via a first user action, i.e., depression to a first level, the electrical connection between the power source (224) and the lighting element (212) is completed such that a closed circuit is formed and a lighting pattern (428) is disposed on the application surface (432) as depicted in FIG. 5B. In FIG. 5B, the actuating device (108) in the first position is distinct from the inactivated position depicted in FIG. 5A. Note that when in the first activated position, the composition (FIG. 3, 314) is still not flowing through the opening (210). In other words, the actuating device (108), when in a first position, activates the lighting device (106) independently from the dispensing device (FIG. 1, 104). Doing so is beneficial in that the target area can be visualized and seen before the composition (FIG. 3, 314) is deposited on the application surface (432).

When in a second activated position, for example, as a user depresses the first rod (213) further, the actuating device (FIG. 1, 108) continues to activate the lighting device (106), but simultaneously activates the dispensing device (FIG. 1, 104) as depicted in FIG. 5C. In other words, the composition (FIG. 3, 314) is permitted to exit via the opening (210) as indicated by the arrows (426) that corresponds to the dispersal pattern (430) on the application surface (432). Note that once the actuating device (FIG. 1, 108) is returned to the inactivated position depicted in FIG. 5A, the lighting element (212) remains on for a period of time due to the storage of electrical potential in the capacitor (534), which upon release of the actuating device (FIG. 1, 108) continues to supply electrical power to the lighting element (212) for a period of time.

In summary, in the examples depicted in FIGS. 5A-5C, the actuating device (FIG. 1, 108) has a first activated position, which is a first depressed position, wherein just the lighting device (106) is activated. The actuating device (FIG. 1, 108) also has a second activated position, which is a second depressed position, wherein the lighting device (106) and the dispensing device (FIG. 1, 104) are both activated. While FIGS. 4A-5C depict a single actuating device (FIG. 1, 108) for activating the lighting device (106) and the dispensing device (FIG. 1, 104), multiple actuating devices (FIG. 1, 108) may be implemented. For example, a first actuating device (FIG. 1, 108) to activate the lighting device (106), and a second actuating device (FIG. 1, 108) to activate the dispensing device (FIG. 1, 104).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A composition container comprising:
a reservoir to hold a volume of a composition;
a dispensing device to dispense the composition from the reservoir onto an application surface;
a lighting device to illuminate a target area of the application surface during the dispensing of the composition from the reservoir onto the application surface; and
an actuating device to selectively activate the dispensing device and the lighting device.

2. The container of claim 1, wherein the lighting device comprises a light emitting diode (LED) lighting element to illuminate the target area.

3. The container of claim 1, wherein the lighting device comprises an ultraviolet (UV) lighting element to illuminate the target area.

4. The container of claim 1, wherein the actuating device comprises a single actuating device that, when in a first position, activates the lighting device independently from the dispensing device.

5. The container of claim 4, wherein the single actuating device, when in a second position, simultaneously activates the lighting device and the dispensing device.

6. The container of claim 5, wherein the single actuating device, when in the first position and the second position, closes an electrical circuit between a battery of the lighting device and a lighting element of the lighting device.

7. The container of claim 1, wherein the dispensing device dispenses the composition from the reservoir as a spray.

8. The container of claim 1, wherein the lighting device illuminates a target area that is larger than an area covered during the dispensing of the composition from the reservoir onto the application surface.

9. The container of claim 1, wherein the reservoir is an aerosolized reservoir to contain a pressurized composition.

10. The container of claim 1, wherein the actuating device comprises a first actuator to activate the lighting device and a second actuator to activate the dispensing device.

11. A consumer product comprising:
a reservoir to hold a volume of a composition;
a consumer composition disposed within the reservoir;
a dispensing device coupled to the reservoir to eject a portion of the consumer composition onto an application surface;
a lighting device to illuminate a target area of the application surface during ejection of the portion of the consumer composition onto the application surface; and
an actuating device to activate both the lighting device and the dispensing device.

12. The consumer product of claim 11, wherein:
the reservoir is an aerosolized reservoir to contain a pressurized composition; and
the dispensing device is an aerosol dispensing device.

13. The consumer product of claim 11, wherein the reservoir is a non-aerosolized reservoir to contain a composition at atmospheric pressure.

14. The consumer product of claim 11, wherein the composition is a personal care composition.

15. The consumer product of claim 11, wherein the composition is at least one of a fluid, a gel, an emulsion, a foam, or a foaming gel.

16. The consumer product of claim 11, wherein the composition is selected from the group consisting of a hairspray, an antiperspirant spray, an antiperspirant deodorant spray, a surface cleaner, a fabric cleaner, a bug spray, an adhesive, or a spray paint.

17. The consumer product of claim 11, wherein the actuating device, in at least one position, simultaneously activates the lighting device and the dispensing device.

18. The consumer product of claim 11, wherein a power source of the lighting device is coupled to the reservoir.

19. A composition container comprising:
a reservoir to hold a volume of a personal care composition;
a dispensing device to dispense a portion of the personal care composition from the reservoir onto an application surface;
a lighting device to illuminate a target area of the application surface during ejection of the portion of the personal care composition onto the application surface, wherein the lighting device comprises:
a lighting element to illuminate the target area; and
a power source to provide electrical power to activate the lighting element; and
an actuating device to activate the dispensing device and the lighting device, wherein:
when in a first activated position, the actuating device activates the lighting device; and
when in a second activated position, the actuating device activates the lighting device and the dispensing device.

20. The container of claim 19, wherein:
the first activated position is a first depressed position; and
the second activated position is a second depressed position.
